(19) United States
(12) Patent Application Publication
(10) Pub. No.: US 2024/0060438 A1
(43) Pub. Date: Feb. 22, 2024

(54) SYSTEM AND METHOD FOR CARBON DIOXIDE CAPTURE/STORAGE FROM ENGINE EXHAUST

(71) Applicant: Southwest Research Institute, San Antonio, TX (US)

(72) Inventors: Graham T. CONWAY, San Antonio, TX (US); Thomas E. BRIGGS, JR., Helotes, TX (US); Terrence F. ALGER, III, San Antonio, TX (US); Jason Daniel HERRERA, San Antonio, TX (US)

(21) Appl. No.: 18/297,806

(22) Filed: Apr. 10, 2023

Related U.S. Application Data
(60) Provisional application No. 63/371,687, filed on Aug. 17, 2022.

(51) Int. Cl. F01N 3/08; F17C 5/06

(52) U.S. Cl. CPC F01N 3/0857; F17C 5/06; F01N 2330/06; F01N 2370/22; F01N 2570/10; F17C 2221/013; F17C 2223/0123; F17C 2270/0168

(57) ABSTRACT

A system and method for carbon dioxide capture/storage from exhaust utilizing a carbon dioxide separation membrane which may be prepared in the form of a monolithic structure. The captured carbon dioxide may also be stored in a fluid state as supercritical CO₂. An integrated fuel delivery and carbon dioxide unloading system is also disclosed, to remove carbon dioxide from a vehicle for sequestration or other industrial purposes.

### CROSS-REFERENCE TO RELATED APPLICATIONS

This application claims the benefit of and priority from U.S. Provisional Application No. 63/371,687 filed Aug. 17, 2022.

### FIELD

The present invention is directed at a system and method for carbon dioxide capture/storage from engine exhaust. The captured carbon dioxide may be stored in a fluid state as supercritical CO₂. An integrated fuel delivery and carbon dioxide unloading system is also disclosed, to remove carbon dioxide from the exhaust for sequestration or other industrial purposes.

### BACKGROUND

Reduction in carbon dioxide (CO₂) emissions from exhaust, and in particular vehicular exhaust, has become a focal point of the transportation industry. This is underscored by Environmental Protection Agency (EPA) reports that carbon dioxide (CO₂) is the primary greenhouse gas emitted through human activities. In 2020, CO₂ accounted for about 79% of all U.S. greenhouse gas emissions from human activities. See, Inventory of U.S. Greenhouse Gas Emissions and Sinks: 1990-2020. U.S. Environmental Protection Agency, EPA 430-R-22-003. U.S. Pat. No. 8,454,732 reports on a membrane composition and process for its formation for the removal of CO2 from mixed gases. The membrane includes a substrate layer comprising inorganic oxides, a barrier layer of in-situ formed Li₂ZrO₃, a Li₂ZrO₃ sorbent layer and an inorganic oxide cap layer.

A growing need remains for the development of systems and methods for CO₂ capture from engine exhaust, and in particular vehicle exhaust, that can preferably be recovered in a fluid state along with integrated fuel delivery system to remove CO₂ from the vehicle for other commercial applications.

### SUMMARY

A method for selectively capturing and storing carbon dioxide from vehicle exhaust gas comprising providing vehicle exhaust gas that contains carbon dioxide and contacting the vehicle exhaust gas with a carbon dioxide separation membrane comprising a metal oxide selected from the group consisting of Li₂ZrO₃, Li₅AlO₄, Li₄SiO₄, Li₄TiO₄, Li₆Zr₂O₇, Li₂CuO₂, Li₂SiO₃, Na₂ZrO₃ and mixtures thereof. Carbon dioxide is then removed from the vehicle exhaust followed by converting the removed carbon dioxide from the vehicle exhaust into supercritical carbon dioxide (sCO₂) and storing the sCO₂ in a vessel in the vehicle.

A system for selectively capturing and storing carbon dioxide from vehicle exhaust gas comprising a carbon dioxide separation membrane comprising a metal oxide selected from the group consisting of Li₂ZrO₃, Li₅AlO₄, Li₄SiO₄, Li₄TiO₄, Li₆Zr₂O₇, Li₂CuO₂, Li₂SiO₃, Na₂ZrO₃ and mixtures thereof, wherein said membrane is configured to remove carbon dioxide from vehicle exhaust; a cooler configured to receive carbon dioxide removed from the vehicle exhaust; a compressor configured to receive the cooled carbon dioxide and compress the cooled carbon dioxide and form supercritical carbon dioxide (sCO₂); and a sCO₂ storage vessel to receive the sCO₂ from the compressor.

A carbon dioxide separation membrane comprising a monolithic structure wherein the monolithic structure comprises a metal oxide selected from the group consisting of Li₂ZrO₃, Li₅AlO₄, Li₄SiO₄, Li₄TiO₄, Li₆Zr₂O₇, Li₂CuO₂, Li₂SiO₃, Na₂ZrO₃ and mixtures thereof.

A carbon dioxide separation membrane comprising a plurality of sections or layers of a metal oxide wherein the metal oxide is selected from the group consisting of Li₂ZrO₃, Li₅AlO₄, Li₄SiO₄, Li₄TiO₄, Li₆Zr₂O₇, Li₂CuO₂, Li₂SiO₃, or Na₂ZrO₃, wherein one section or layer has a first metal oxide (MO₁) composition, one section or layer has a second metal oxide composition (MO₂), wherein MO₁ is compositionally different from MO₂.

### BRIEF DESCRIPTION OF THE DRAWINGS

FIG. 1 provides a flow-diagram illustrating the use of a carbon dioxide separation membrane in a spark-initiated engine.

FIG. 2 provides a flow-diagram illustrating the use of a carbon dioxide separation membrane in a compression-initiated engine.

FIG. 3 illustrates a monolithic ceramic honeycomb type structure with Li₂ZrO₃ selectively deposited thereon.

FIG. 4 illustrates a ceramic honeycomb structure where the referenced honeycomb passages are arranged in a grid.

### DETAILED DESCRIPTION

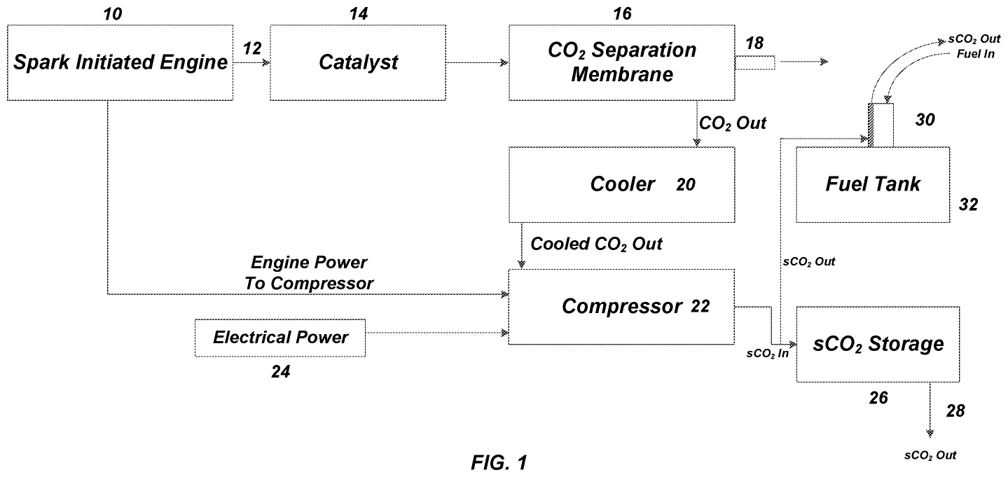

FIG. 1 illustrates a preferred embodiment of the present invention as applied to a spark-initiated internal combustion engine 10 with an exhaust flow 12 that is introduced to catalyst 14. However, in the broad context of the present invention, the CO₂ separation membrane herein may be employed in stationery engines or in exhaust stack applications for any system which has elevated CO₂ emissions. The discussion herein for an internal combustion engine is therefore exemplary for CO₂ separation membrane herein.

In FIG. 1, catalyst 14 may therefore preferably include a three-way catalyst (TWC) which permits conversion of three combustion pollutants, CO, hydrocarbons and NOx. More specifically, reduction of nitrogen oxides into elemental nitrogen and oxygen (NOx→Nx+Ox), oxidation of carbon monoxide to carbon dioxide (CO+O₂→CO₂) and oxidation of hydrocarbons into carbon dioxide and water (CxH4x+2xO2→xCO+2x H₂O). The output of catalyst 14 now proceeds to the CO₂ separation membrane 16. Such separation membrane acts to selectively remove CO₂ from the exhaust stream 12, which exhaust stream proceeds out of the engine typically through an engine tailpipe. It is contemplated that 20% or more of the CO₂ in the exhaust stream is removed by the separation membrane 16. More preferably, 20% to 90% of the CO₂ in the exhaust stream can be removed from the exhaust stream, including all values and increments therein.

Preferably, the CO₂ separation membrane 16 is porous and configured to separate CO₂ from the exhaust stream at temperatures of at or above 400° C. More preferably, the separation membrane 16 operates in the range of 400° C. to 700° C. The separation membrane itself is preferably selected from the group of metal oxides consisting of Li₂ZrO₃, Li₅AlO₄, Li₄SiO₄, Li₄TiO₄, Li₆Zr₂O₇, Li₂CuO₂, Li₂SiO₃, Na₂ZrO₃ and mixtures thereof. One particularly preferred separation membrane is Li₂ZrO₃.

The membrane can optionally include a substrate layer comprising inorganic oxides, a barrier layer of, e.g., in-situ formed Li₂ZrO₃, a Li₂ZrO₃ sorbent layer, and an inorganic oxide cap layer. Reference is made to U.S. Pat. No. 8,454,732 whose teachings are incorporated by reference.

The separation membrane may also preferably comprise a porous ceramic substrate containing a layer of the metal oxides noted above, namely Li₂ZrO₃, Li₅AlO₄, Li₄SiO₄, Li₄TiO₄, Li₆Zr₂O₇, Li₂CuO₂, Li₂SiO₃, Na₂ZrO₃ and mixtures thereof. The porous ceramic itself is selected to that it will preferably withstand the thermal and mechanical stresses imposed in vehicle exhaust use. The ceramic substrate may preferably have a porosity of 20% to 80% including all individual values and increments therein. In such manner, the aforementioned metal oxide(s) are supported by the porous ceramic substrate without the aforementioned requirement of a barrier layer, sorbent layer and inorganic oxide cap layer. More preferably, the separation membrane may comprise a monolithic ceramic honeycomb structure, as disclosed further herein. The ceramic substrate may itself preferably have a thickness of 6.0 mm to 15.0 mm, including all individual values and increments therein. The aforementioned metal oxide(s) are preferably present on the porous ceramic substrate at a thickness in the range of 10.0 μm to 100.0 μm and a porosity from 0 to 30%.

The CO₂ existing, the separation membrane and removed from the exhaust, which is at an elevated temperature relative to ambient air, may then be directed to a cooler 20, where it is cooled to a temperature sufficient for introduction into the compressor 22. The temperature of the exhaust may preferably be cooled to fall in the range of 30° C. to 100° C., including all individual values and increments therein. The CO₂ that is removed, the membrane which then moves through the cooler to the compressor is preferably done under vacuum, where one may then preferably include a separate vacuum pump.

The compressor 22 is preferably a multi-stage compressor with intercooling between the stages to maintain near isothermal operation to increase the pressure of the cooled CO₂ from 1 bar to above 80 bar where the cooled CO₂ will enter the supercritical state and become supercritical CO₂ (sCO₂). Namely CO₂ at a temperature above 31.1° and pressures above 1071 psi. It is contemplated, however, that any compressor machinery that can achieve the compression performance to provide sCO₂ may be employed, and as illustrated in FIG. 1, the compressor is preferably driven mechanically by the engine. The compressor may also be driven electrically, such as in a hybrid type vehicle, where electrical energy power 24 is stored and available.

The sCO₂ is then directed to a sCO₂ storage vessel or tank 26 to store the sCO₂ until it can be removed from the vehicle, which preferably can occur during a refueling operation. The storage vessel or tank 26 is therefore preferably made of insulating material to contain the sCO₂ and can be located at various locations within the vehicle. Preferably, the vessel or tank 26 can have a capacity of 75 kg to 150 kg, including all individual values and increments therein. The preferred size of the vessel or tank 26 can be altered depending upon the fuel utilized, as different fuels will yield different amounts of CO₂ per gallon of fuel consumed. The sCO₂ storage vessel or tank 26 may itself have a dedicated nozzle 28 for removal/recovery of the sCO₂, sourced from the vehicle exhaust, for use in other industrial applications.

The sCO₂ contained in storage vessel or tank 26 may also be preferably connected to a nozzle 30 connected to fuel tank 32. The nozzle 30 therefore provides a positive seal with the sCO₂ storage tank to maintain the CO₂ in the supercritical state as it is removed from the storage vessel or tank 26 at a refueling station. The removed sCO₂ may then be directed, e.g., into a sCO₂ pipeline for underground sequestration and storage, and again, ultimately for other industrial applications.

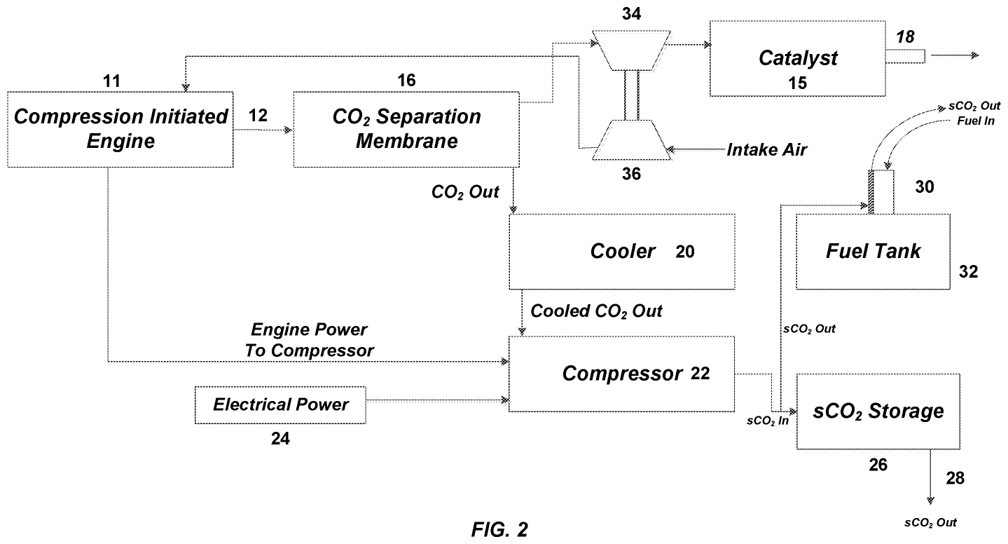

As now illustrated in FIG. 2, the above removal of CO₂ from a spark-initiated internal combustion engine can also be configured for a compression-initiated internal combustion engine. For this case, the exhaust exiting the compression-initiated engine 11 is preferably fed directly to the CO₂ separation membrane 12 which then similarly provides the output of CO₂ to the cooler 20, and then onto compressor 22 for formation of sCO₂, which can be stored in a vessel or tank 26. The CO₂ that is removed, the membrane which then moves through the cooler to the compressor is preferably done under vacuum, where one may then preferably include a separate vacuum pump. Vessel or tank 26 can again directly provide for removal of CO₂ through a dedicated nozzle 28. In addition, the sCO₂ storage vessel may again be connected to nozzle 30 that is connected to fuel tank 32 (containing a hydrocarbon fuel) so that the sCO₂ can be removed at the time of refueling.

Moreover, the exhaust from the compression-initiated engine, with the CO₂ now removed, can then be routed to a turbine 34 connected to a compressor 36 for delivery of compressed air to the intake manifold (not shown) of the compression-initiated engine 11. Similar to the above, it is again contemplated that 20% or more of the CO₂ in the exhaust stream from the compression-initiated engine is removed. More preferably, 20% to 90% of the CO₂ in the exhaust stream can be removed, including all values and increments therein. This exhaust with such reduced level of CO₂ that emerges from the CO₂ separation membrane and can then preferably be routed to the turbine 34. The exhaust exiting the turbine can also then be treated by catalyst 15 appropriate for diesel emissions and then expelled through an exhaust tailpipe 18 to the atmosphere.

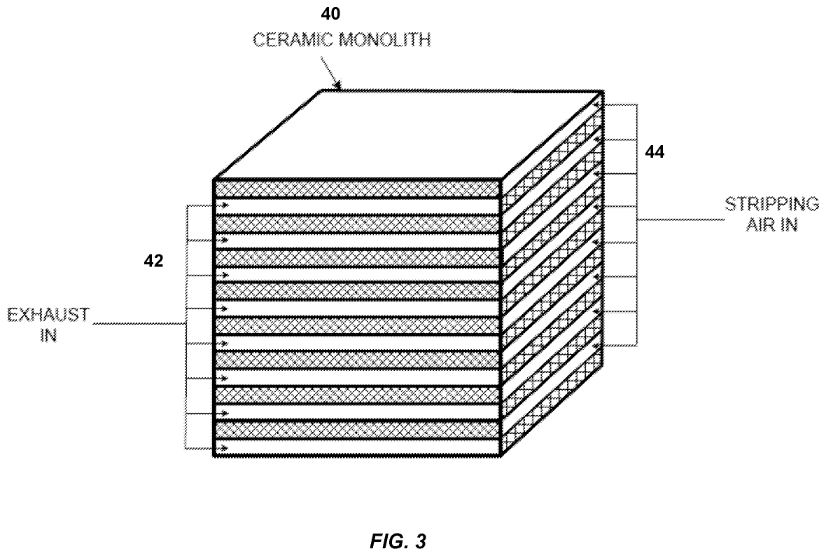

As alluded to above, the CO₂ separation membrane for use in the vehicle may now in one configuration preferably comprises a monolithic ceramic honeycomb type structure 40, containing a deposited layer of metal oxides noted above, namely Li₂ZrO₃, Li₅AlO₄, Li₄SiO₄, Li₄TiO₄, Li₆Zr₂O₇, Li₂CuO₂, Li₂SiO₃, Na₂ZrO₃ and mixtures thereof, as illustrated in FIG. 3.

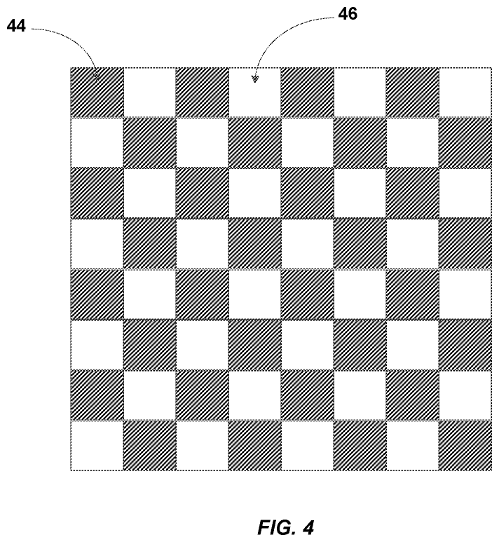

Reference to a ceramic is reference to an inorganic oxide, such as MgO₂, Al₂O₃ or SiO₂. Reference to a honeycomb structure is reference to a lattice of hollow, relatively thin-wall cells, which may be hexagonal or columnar. Reference to monolithic is reference to unitary and continuous ceramic structure, without, e.g., separately adhered layers of ceramic material. The ceramic honeycomb may also be sourced from cordierite ceramic, a magnesium aluminum silicate material. In a preferred configuration, the plurality of exhaust passages 42 in the ceramic structure are preferably arranged at right angles to the plurality of stripping air passages 44. It should also be appreciated that the exhaust passages 42 and stripping air passages 44 may be in the same direction (parallel) or in a fully opposite direction (counterflow). FIG. 4 illustrates another preferred configuration where the above referenced honeycomb passages may preferably be arranged in a grid. As illustrated exhaust channels are shown at 44 and stripping air channels are shown at 46.

It is also worth noting that regardless of the orientation of the channels within the ceramic honeycomb monolith, the preferred feature worth emphasizing is that one provides separate paths for the exhaust flow and the stripping air flow wherein the ceramic containing the layer of metal oxides noted above, namely Li₂ZrO₃, Li₅AlO₄, Li₄SiO₄, Li₄TiO₄, Li₆Zr₂O₇, Li₂CuO₂, Li₂SiO₃, Na₂ZrO₃ and mixtures thereof, are separating the two air flows. The exhaust flow entering the ceramic honeycomb monolith and entering stripping air may therefore be divided as also shown in FIG. 3.

It is also preferable herein to form the carbon dioxide separation membrane herein directly from the metal oxide, which again preferably includes Li₂ZrO₃, Li₅AlO₄, Li₄SiO₄, Li₄TiO₄, Li₆Zr₂O₇, Li₂CuO₂, Li₂SiO₃, Na₂ZrO₃ and mixtures thereof. The separation membrane may then preferably be in the form of a one-piece monolithic structure, which is therefore composed of one or more of the above metal oxides without joints or seams. Such monolithic structure may also be made porous and have a porosity in the range of 20% to 80%, including all individual values and increments therein.

In addition, one may provide a plurality of monolithic tubular structures for those applications that may require a tubular style membrane. The monolithic tubes, made of one or more of the aforementioned metal oxides (Li₂ZrO₃, Li₅AlO₄, Li₄SiO₄, Li₄TiO₄, Li₆Zr₂O₇, Li₂CuO₂, Li₂SiO₃, Na₂ZrO₃ and mixtures thereof) can then be preferably retained or supported in a metal housing.

It should therefore be appreciated that the carbon dioxide separation membrane herein can be made to have a plurality of individual sections or layers, where each section or layer may be selected from one of the following metal oxides: Li₂ZrO₃, Li₅AlO₄, Li₄SiO₄, Li₄TiO₄, Li₆Zr₂O₇, Li₂CuO₂, Li₂SiO₃, or Na₂ZrO₃. Accordingly, it is contemplated that one may now produce a carbon dioxide separation membrane wherein one section or layer of the membrane is selectively formed from a first metal oxide (MO₁) selected from one of Li₂ZrO₃, Li₅AlO₄, Li₄SiO₄, Li₄TiO₄, Li₆Zr₂O₇, Li₂CuO₂, Li₂SiO₃, or Na₂ZrO₃. Another section or layer of the membrane is then formed from a different metal oxide (MO₂) wherein MO₁ is compositionally different from MO₂. The membrane formed, as noted, can therefore have individual metal oxide layers that are compositionally different, while each provides carbon dioxide separation.

Expanding on the above, one may now therefore form a carbon dioxide separation membrane with a plurality of sections, wherein one section of the separation membrane is formed from a first metal oxide (MO₁) and another section of the monolithic separation membrane is formed from a second metal oxide (MO₂). Reference to a section of the carbon dioxide separation membrane is a reference to a particular portion or region of the membrane. Again, MO₁ is compositionally different from MO₂ and the metal oxide is selected from the group consisting of Li₂ZrO₃, Li₅AlO₄, Li₄SiO₄, Li₄TiO₄, Li₆Zr₂O₇, Li₂CuO₂, Li₂SiO₃, or Na₂ZrO₃.

It is contemplated that the monolithic carbon dioxide membrane made of metal oxide is preferably formed herein by one or more of the following contemplated techniques:

Sintering: This involves heating the metal oxide powder at relatively high temperatures to form a solid, rigid structure. During sintering, the metal oxide powder particles are heated to a temperature where they fuse together, forming a solid mass. The temperature required for sintering depends on the composition of the powder, but preferably ranges from 1200° C. to 1600° C.

Hot pressing: This involves applying pressure and heat simultaneously to the metal oxide powder to create a relatively dense, rigid structure. The powder is placed in a die and then heated to a temperature below its melting point. A hydraulic press may be used to apply pressure to the metal oxide powder, compacting it into a dense structure. The temperature and pressure required for hot pressing depends on the composition of the powder, but preferably ranges from 1000 to 1500° C. and 50 to 200 MPa.

Cold pressing and sintering: This technique involves compacting the metal oxide powder into a specific shape using a cold press, followed by sintering to create a relatively rigid structure. In this process, the metal oxide powder is first pressed at room temperature using a die and press, forming a compact. The compact is then sintered at high temperature to form the desired membrane.

Tape casting: This is a process in which a slurry of the metal powder is cast onto a flexible substrate, such as a polymer film, and then dried to create a thin, flexible sheet. The sheet can then be cut into the desired shape and sintered to create the desired membrane.

Additive manufacturing: This is a process in which the metal oxide powder is layered in a specific pattern using a 3D printer or similar device, creating a solid structure. The layers are bonded together using heat or a chemical process, creating a relatively rigid structure. Specific examples of additive manufacturing are contemplated to include: selective laser sintering, selective laser melting, stereo-lithography, fused deposition modelling and direct energy deposition

As therefore may now be further appreciated, one may form a carbon dioxide separation membrane whereby utilizing compositionally different metal oxides at different layers or sections of the membrane, one can provide a carbon dioxide separation membrane that provides individual layers or sections with different temperature activation requirements to activate the membrane for removal of carbon dioxide. Accordingly, carbon dioxide separation can now be made to selectively activate with temperature at any given layer or section of the membrane, as a function of metal oxide composition, which membrane section then operates to remove carbon dioxide.

As can now be appreciated, the disclosure herein provides a system and method for carbon dioxide capture/storage from engine exhaust, and in particular vehicular engine exhaust. This system and method are contemplated to be particularly beneficial where fuels with relatively low or zero carbon intensity are utilized. These fuels are derived from renewal resources such as biomass or solar/wind energy. With such fuels, it is contemplated that the carbon dioxide capture/storage herein will turn the overall carbon cycle for the vehicle into a net negative carbon source (i.e., the vehicle removes carbon dioxide from the atmosphere on balance). By way of example, for a vehicle operating on 100% ethanol, only around 20% of the exhaust carbon dioxide must be captured and stored before the total carbon dioxide emission is net negative for the vehicle.

What is claimed is:

1. A method for selectively capturing and storing carbon dioxide from vehicle exhaust gas comprising:
providing vehicle exhaust gas that contains carbon dioxide;
contacting said vehicle exhaust gas with a carbon dioxide separation membrane comprising a metal oxide selected from the group consisting of Li₂ZrO₃, Li₅AlO₄, Li₄SiO₄, Li₄TiO₄, Li₆Zr₂O₇, Li₂CuO₂, Li₂SiO₃, Na₂ZrO₃ and mixtures thereof;
removing carbon dioxide from said vehicle exhaust;
converting the removed carbon dioxide from said vehicle exhaust into supercritical carbon dioxide (sCO₂) and storing said sCO₂ in a vessel in said vehicle.

2. The method of claim 1 wherein said carbon dioxide membrane comprises Li₂ZrO₃ on a ceramic support.

3. The method of claim 1 wherein said vehicle exhaust is exhaust from a spark-initiated internal combustion engine.

4. The method of claim 1 wherein said vehicle exhaust is exhaust from a compression-initiated internal combustion engine.

5. The method of claim 2 wherein said ceramic support comprises a ceramic monolithic structure.

6. The method of claim 1 wherein 20% or more of the carbon dioxide in said vehicle exhaust is removed by said carbon dioxide separation membrane.

7. The method of claim 1 wherein 20% to 90% of the carbon dioxide in said vehicle exhaust is removed by said carbon dioxide separation membrane.

8. The method of claim 1 wherein said stored sCO₂ in said vessel in said vehicle is connected to a nozzle of a vessel fuel tank wherein said stored sCO₂ is configured to be removed from said vessel when said vehicle is refueled.

9. The method of claim 1 wherein said carbon dioxide separation membrane comprises a monolithic structure.

10. The method of claim 1 wherein said carbon dioxide separation membrane comprises a plurality of sections or layers of a metal oxide wherein the metal oxide is selected from the group consisting of Li₂ZrO₃, Li₅AlO₄, Li₄SiO₄, Li₄TiO₄, Li₆Zr₂O₇, Li₂CuO₂, Li₂SiO₃, or Na₂ZrO₃, wherein one section or layer has a first metal oxide (MO₁) composition, one section or layer has a second metal oxide composition (MO₂), wherein MO₁ is compositionally different from MO₂.

11. A system for selectively capturing and storing carbon dioxide from vehicle exhaust gas comprising:
a carbon dioxide separation membrane comprising a metal oxide selected from the group consisting of Li₂ZrO₃, Li₅AlO₄, Li₄SiO₄, Li₄TiO₄, Li₆Zr₂O₇, Li₂CuO₂, Li₂SiO₃, Na₂ZrO₃ and mixtures thereof, wherein said membrane is configured to remove carbon dioxide from vehicle exhaust;
a cooler configured to receive carbon dioxide removed from said vehicle exhaust;
a compressor configured to receive said cooled carbon dioxide and compress said cooled carbon dioxide and form supercritical carbon dioxide (sCO₂); and
a sCO₂ storage vessel to receive the sCO₂ from said compressor.

12. The system of claim 11 wherein said carbon dioxide separation membrane comprises Li₂ZrO₃ on a ceramic support.

13. The system of claim 11 wherein said vehicle exhaust is exhaust from a spark-initiated internal combustion engine.

14. The system of claim 11 wherein said vehicle exhaust is exhaust from a compression-initiated internal combustion engine.

15. The system of claim 12 wherein said ceramic support comprises a ceramic monolithic structure.

16. The system of claim 11 wherein 20% or more of the carbon dioxide in said vehicle exhaust is removed by said carbon dioxide separation membrane.

17. The system of claim 11 wherein 20% to 90% of the carbon dioxide in said vehicle exhaust is removed by said carbon dioxide separation membrane.

18. The system of claim 11 wherein said sCO₂ storage vessel is connected to a nozzle of a vessel fuel tank wherein said stored sCO₂ is configured to be removed from said vessel when said vehicle is refueled.

19. The system of claim 11 wherein said carbon dioxide separation membrane comprises a monolithic structure.

20. The system of claim 11 wherein said carbon dioxide separation membrane comprises a plurality of sections or layers of a metal oxide wherein the metal oxide is selected from the group consisting of Li₂ZrO₃, Li₅AlO₄, Li₄SiO₄, Li₄TiO₄, Li₆Zr₂O₇, Li₂CuO₂, Li₂SiO₃, or Na₂ZrO₃, wherein one section or layer has a first metal oxide (MO₁) composition, one section or layer has a second metal oxide composition (MO₂), wherein MO₁ is compositionally different from MO₂.

21. A carbon dioxide separation membrane comprising a monolithic structure wherein said monolithic structure comprises a metal oxide selected from the group consisting of Li₂ZrO₃, Li₅AlO₄, Li₄SiO₄, Li₄TiO₄, Li₆Zr₂O₇, Li₂CuO₂, Li₂SiO₃, Na₂ZrO₃ and mixtures thereof.

22. A carbon dioxide separation membrane comprising a plurality of sections or layers of a metal oxide wherein the metal oxide is selected from the group consisting of Li₂ZrO₃, Li₅AlO₄, Li₄SiO₄, Li₄TiO₄, Li₆Zr₂O₇, Li₂CuO₂, Li₂SiO₃, or Na₂ZrO₃, wherein one section or layer has a first metal oxide (MO₁) composition, one section or layer has a second metal oxide composition (MO₂), wherein MO₁ is compositionally different from MO₂.
